(19) United States
(12) Patent Application Publication
(10) Pub. No.: US 2006/0008600 A1
(43) Pub. Date: Jan. 12, 2006

(54) Microwavable packaging material

(75) Inventors: Stephen George Appleton, Farnborough (GB); Andrew Shaun Treen, Farnborough (GB); Ian John Youngs, Salisbury (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: QinetiQ Limited

(21) Appl. No.: 10/527,106

(22) PCT Filed: Sep. 5, 2003
(86) PCT No.: PCT/GB03/03861

§ 371 Date: Mar. 8, 2005

(30) Foreign Application Priority Data
Sep. 12, 2002 (GB) 0221099.5

(51) Int. Cl. B29D 22/00

(52) U.S. Cl. 428/34.1

(57) ABSTRACT

A material for use in covering objects for microwave heating comprises a substrate (1) substantially transparent to microwave radiation bearing an array of low emissivity metal patch elements (2) defining a frequency selective surface adapted to pass microwave radiation and reflect thermal infrared radiation. The patch elements (2), typically of aluminium, preferably have a characteristic dimension no greater than about 500 μm and a spacing no greater than about 100 μm, while the emissivity of the combined surface and frequency selective surface is preferably no greater than about 0.4. The material is useful as a packing for chilled or frozen microwavable foodstuffs, where its low emissivity assists in thermal insulation during storage or transportation and capturing of heat within the package during microwave cooking, where it can be safely used despite the presence of metal in the structure due to its configuration as a frequency selective surface. Potential uses also include bandages or patches worn on the body during microwave heat treatment of sports injuries and the like and various other microwave heating applications.

The present invention relates to a material for use in packaging or otherwise covering objects for microwave heating. The invention is more particularly concerned with a material for use in microwavable food packaging although it may also find application in, for example, bandages and patches adapted to be worn on the body during microwave heat treatment of sports injuries and the like, or in other microwave heating applications such as wood or paper drying, curing of composites, firing of ceramics or thawing of cryogenically preserved samples.

Conventional microwavable food packaging consists of polymeric or paper-based materials which are transparent to microwave radiation. The use of electroconductive materials, such as metal foils, within microwave ovens (typically operating at around 2.45 GHz) is generally to be avoided as they are inherently reflective to microwave radiation and can cause arcing within the cavity and risk destruction of the magnetron. On the other hand, it would be desirable to incorporate a low emissivity (ie highly reflective) metal foil in the packaging of chilled and frozen microwavable foodstuffs as such a material can reduce the transfer of heat due to thermal infrared (IR) radiation or in other words enhance the thermal insulation properties of the packaging. This would usefully prolong the time for which the foodstuff can remain cool or frozen e.g. between being purchased and refrigerated at home. Similarly, the incorporation of such a foil would tend to keep the foodstuff hotter for longer after heating in the package.

The present invention is predicated on the recognition that it is possible to utilise the desirable IR reflective properties of a metal foil in a microwavable packaging material if it is configured as a so-called frequency selective surface (FSS). This expression refers to the known characteristic that a structure composed of an array of suitably dimensioned electroconductive patch elements can behave as a filter to incident radiation, transmitting at lower frequencies and reflecting at higher frequencies.

The invention accordingly resides in a material for use in covering objects for microwave heating comprising a substrate substantially transparent to microwave radiation bearing an array of low emissivity metal patch elements defining a frequency selective surface adapted to pass microwave radiation and reflect thermal infrared radiation, the characteristic dimension of the patch elements being no greater than about 1600 μm (or more preferably no greater than about 500 μm), the average spacing between the patch elements being no greater than about 200 μm (or more preferably no greater than about 100 μm) and the combined emissivity of the substrate and patch elements being no greater than about 0.8 (or more preferably no greater than about 0.4) in the thermal infrared waveband.

The invention also resides in: a package or packaging material for microwavable foodstuff comprising a material as defined above; a packaged microwavable foodstuff wherein the package comprises a material as defined above; a bandage or patch adapted to be worn on the body comprising a material as defined above; a method of heating an object which comprises covering the object with a material as defined above and exposing the material to microwave radiation; and various methods of manufacturing such a material.

By virtue of the thermal IR reflectivity conferred upon a material according to the invention by the metal (preferably aluminium) patch elements, a chilled or frozen foodstuff packaged in such material may be kept cool or frozen while out of refrigeration for longer than the conventional packaging, but can still be heated in a microwave oven in the same packaging by virtue of the microwave transparency of the FSS. The low emissivity patches may also keep the heated food warmer after microwave exposure, allowing a reduction in the traditional “standing” time which is required for the temperature of microwaved food to even out, increasing the effectiveness of the temperature equalisation during standing, and/or allowing the food to stand for longer before cooling down. The same attribute may increase the versatility of microwave cooking. For example retention of heat in the packaging may allow steaming of food or even cooking from raw.

There may be additional advantages in having a high proportion of the substrate's surface area covered by the metal patches. The metal may act as a barrier to chemical migration and permeation of oxygen into the food, leading to enhanced shelf life. The patches may also have significant reflectivity in the visible and ultraviolet (UV) radiation bands. This may be considered to enhance the aesthetic appeal of the packaging, and limiting the transmission of visible and UV radiation through the packaging may resist discolouration and oxidation of the food, potentially improving shelf life and food quality. In this case an optically transparent substrate may be used instead of the translucent or opaque substrates in conventional microwavable food packaging while the FSS may still permit sufficient light transmission to enable the food to be viewed through the packaging.

The invention will now be more particularly described, by way of example, with reference to the accompanying drawings, in which:

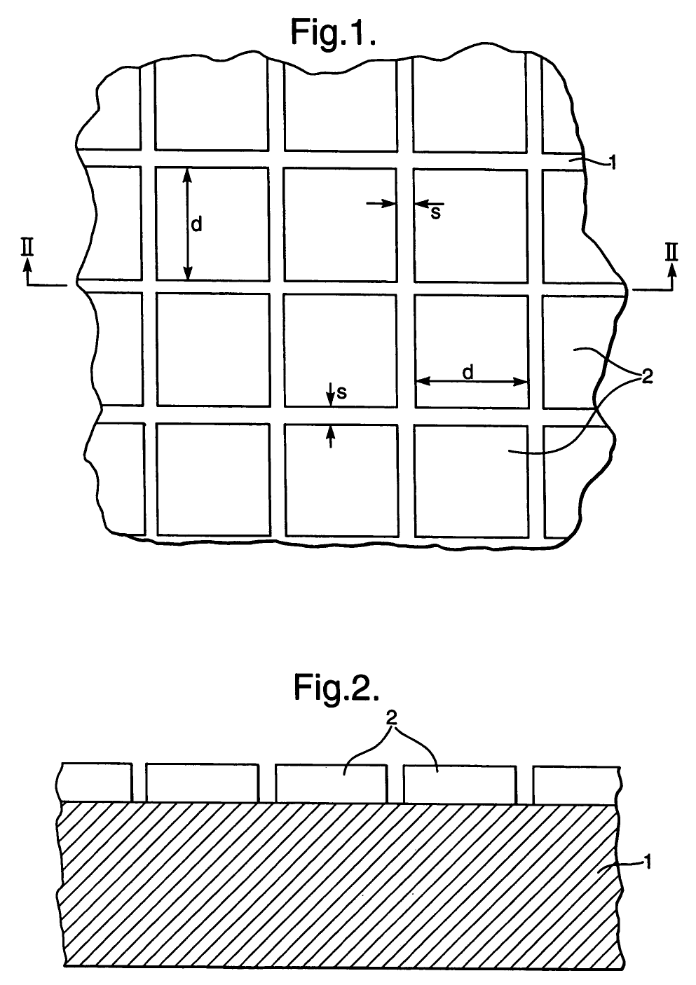

FIG. 1 is a plan view of a portion of a preferred embodiment of microwavable food packaging material according to the invention;

FIG. 2 is a section on the line II-II of FIG. 1;

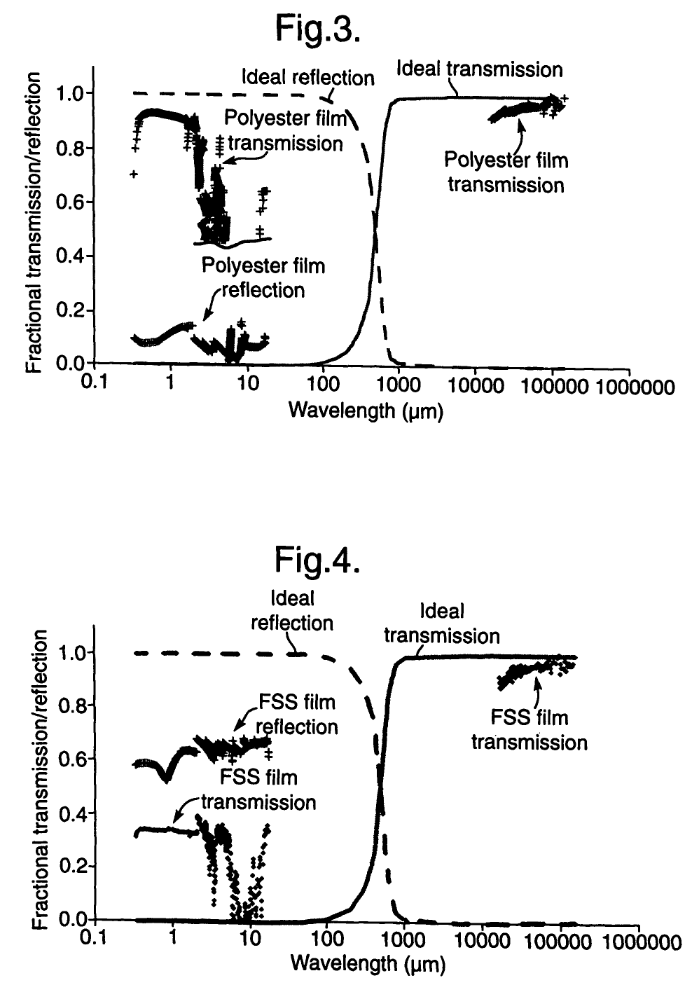

FIG. 3 illustrates the results of transmission and reflection studies into a conventional polyester film material;

FIG. 4 illustrates the results of transmission and reflection studies into an FSS-coated polyester film in accordance with the invention;

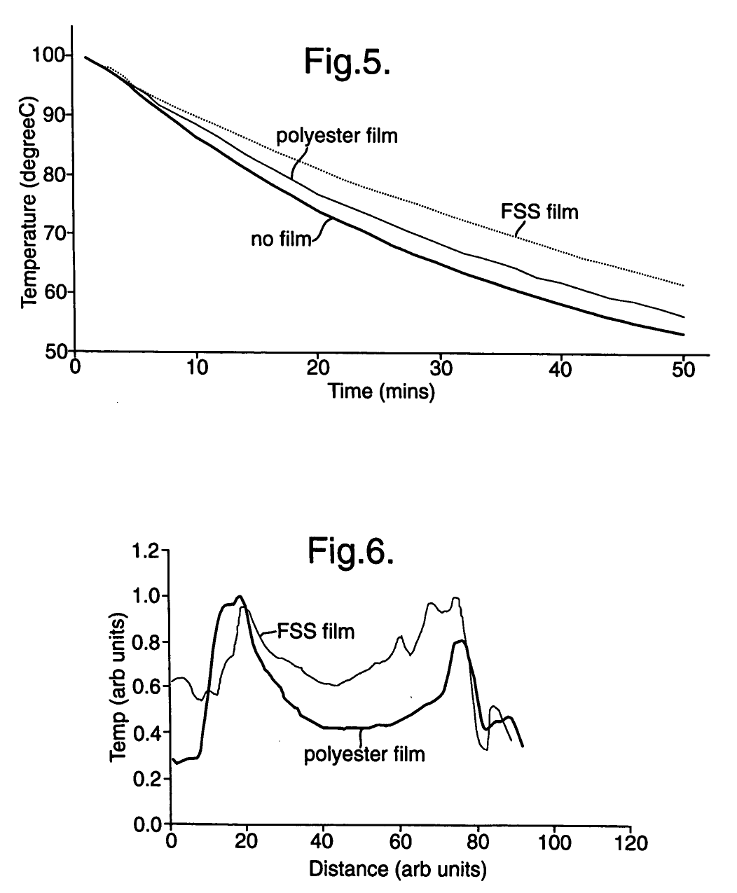

FIG. 5 illustrates comparative cooling curves for heated potatoes with and without the use of a material according to the invention;

FIG. 6 illustrates temperature profiles across heated chicken samples with and without the use of a material according to the invention; and

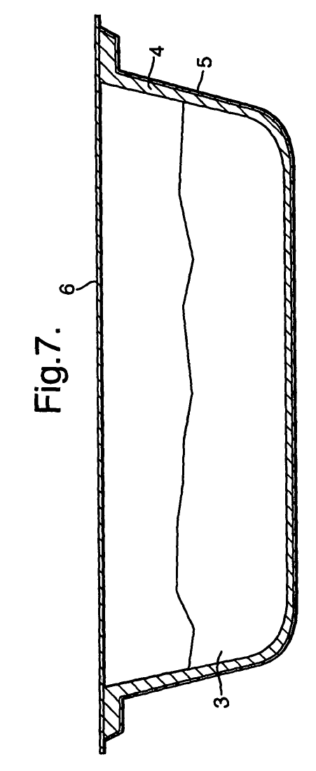

FIG. 7 is a section through one form of a microwavable foodstuff package according to the invention.

Referring to FIGS. 1 and 2, the illustrated embodiment of a microwavable food packaging material according to the invention comprises a microwave-transparent polymer film 1 of, for example, polyester, polypropylene, polyethylene or nylon, upon which is formed a frequency selective surface (FSS) composed of an array of electroconductive patch elements 2 of, for example, aluminium, copper, gold, titanium or chromium. The patch elements are in this case square in shape (of which the characteristic dimension is the side length d), although other shapes are possible, for example rectangles (of which the characteristic dimension is the longer side length), hexagons (of which the characteristic dimension is the distance between opposite sides), circles (of which the characteristic dimension is the diameter) or crosses (of which the characteristic dimension is the span). The purpose of the FSS is to pass microwave radiation, to permit heating in a conventional microwave oven of a foodstuff in a package made from the material, while conferring on the material a sufficiently low emissivity in the thermal IR wavelength range to provide a useful degree of thermal insulation to the contents of the package. These attributes are achieved as follows.

For an FSS to pass radiation of a given frequency it is known that the individual patch elements must be substantially dimensionally smaller than the wavelength at which transparency is required. A conventional design formula is to make the characteristic patch dimension (d in the case of FIG. 1) effectively less than 1/10 of a wavelength. The wavelength of radiation generated in a conventional microwave oven operating at 2.45 GHz is approximately 12 cm, so conventional design practice suggests a characteristic patch dimension up to 12 mm for an FSS to be transparent to such radiation. This does not, however, taken into account the conditions which are likely to prevail in practice in use of a material according to the invention. That is to say, in the course of microwave heating of a foodstuff in a packaging material of this kind it is likely that the material will be in contact with the food over significant areas. Even with the FSS on the external surface the food will be separated from the patch elements only by the thickness of the substrate 1 (typically 20-50 μm) and the close proximity of the foodstuff to the FSS will negatively influence its transparency by virtue of the high relative dielectric permittivity, εᵣ, (typically εᵣ=60) of the adjacent food medium. More particularly we believe that to compensate for the effect of areas of the packaging material touching the food the maximum theoretical characteristic patch dimension of 12 mm derived above should be reduced by a factor of root 60, leading to a maximum dimension of approximately 1600 μm. As an additional safety factor, however, to guarantee substantial transparency of the FSS under all likely operational conditions we prefer to limit the characteristic patch dimension d to no greater than about 500 μm. This will also ensure that in the event of an accidental short circuit between two adjacent patch elements caused by a flaw or defect in the manufacturing process the combined patch size will not cause a significant interaction with the microwaves.

To minimise the emissivity of the illustrated material it is desirable that as much as possible of the surface area of the substrate 1 is covered by metal or in other words that the separation distance s between adjacent patch elements 2 is kept as small as possible, subject to practical manufacturing tolerances. We prefer that the separation distance between adjacent patches is no greater than 200 μm and more preferably is 50-100 μm. In an example where d is 400 μm and s is 100 μm (ie where approximately 65% of the substrate surface is metallised), if the substrate 1 is polyester with an emissivity of 0.98 and patches 2 are aluminium with an emissivity of 0.1 in the thermal IR waveband then the emissivity of the combined material is (0.65×0.1)+(0.35×0.98) or approximately 0.4. The combined emissivity can be reduced still further if required by increasing the percentage of metallised surface area (by increasing the patch size and/or reducing the separation) so with, say, 90% of the substrate surface covered by the patches the emissivity using the same materials as above reduces to (0.9×0.1)+(0.1×0.98) or approximately 0.2.

Although the patch elements 2 are shown in FIG. 1 in a periodic array, in this case a square grid array of identical patches with the same separation distance s around each element, this is not essential to the functioning of the FSS. There could be a less regular array of patches so long as their characteristic dimensions and average spacing are within the specified limits.

The precise thickness of the patch elements 2 is not considered critical, provided that it is above the skin depth necessary for the metal to interact with radiation in the thermal IR waveband and not so great as to affect the microwave transparency of the FSS. In theory this means that these elements can be between nanometres and several tens of μm in thickness. The lower limit of thickness is set by the skin depth ie the depth to which radiation penetrates the surface of the chosen metallic coating. This can be calculated theoretically using well documented formulae, being inversely proportional to the square root of the product of the conductivity of the metal (σ) and frequency of the radiation (f). Using published values for the dc conductivity of aluminium (σ=3.54×10⁻⁷ mho/metres) and a frequency in the middle of the infra-red band (f=7.5×10¹³ Hz) a skin depth of approximately 10 nm is suggested. In practice, however, other issues are likely to determine the chosen thickness of the metallic coating, such as the consistency of the deposition technique, the quality of the deposited metal and cost of the deposited metal. These factors suggest a practical minimum thickness of several tens of nanometres.

It is envisaged that materials according to the invention may be manufactured in bulk in several different ways. Vacuum-coated aluminium-on-polymer films are already in common use as non-microwavable food packaging, eg for potato crisp (in USA chips) and similar snack food packets, and an existing material of this kind may be taken as the starting point in the following process. An etch-resistant ink is gravure printed onto the metal surface of the existing film in a pattern corresponding to the patch elements in the desired FSS configuration. The material is then chemically etched with a standard solution such as sodium hydroxide, hydrochloric acid or ammonium peroxodisulphate to remove the exposed metal between the desired patches. The ink can then be removed from the resultant patches by a suitable solvent if required, although this may not be necessary if the ink is itself sufficiently IR-transparent not to affect the IR reflectivity of the patches.

Alternatively the patch elements can be deposited onto the polymer substrate in the desired FSS configuration from the outset by vacuum coating (eg sputtering) the metal through a mask which leaves portions of the substrate uncoated around each patch.

A third process would be to make use of a metal foil with a heat-sensitive adhesive backing. Such materials are readily available and currently used as the basis of “glittery” gift wraps and similar products. In this case a heated stamp with a pattern corresponding to the patch elements in the desired FSS configuration is used to bond the foil to the substrate, leaving non-bonded portions which are physically stripped away to leave the substrate uncoated around each resultant patch.

### EXAMPLES

In all the following experimental examples the FSS film according to the invention comprised an optically transparent polyester substrate 23 μm thick bearing an array of square aluminium patches 100 nm thick in a grid as illustrated in FIG. 1 with d=300 μm and s=100 μm and the combined emissivity of the material was approximately 0.5 in the thermal IR waveband. The same base polyester film but uncoated with aluminium was used for comparative purposes.

FIGS. 3 and 4 illustrate the results of transmission and reflection studies into the uncoated polyester and FSS films respectively. The x-axis represents the wavelength of radiation and the y-axis represents the fractional transmission or reflectivity through the sample as the case may be, having a scale from 0 to 1 where, in transmission, 0 corresponds to a completely opaque material and 1 to a completely transparent material and, in reflection, 0 corresponds to a completely non-reflective material and 1 to a perfectly reflective material. Both figures also include a representation of the properties of an ideal packaging material for microwavable food, where the solid line illustrates the ideal transmission characteristic and the broken line illustrates the ideal reflection characteristic. That is to say, in the microwave waveband (0.1-30 cm) the ideal packaging is required to be highly transmissive so that the maximum amount of energy reaches its contents from the microwave source and hence ensures that cooking is not inhibited. In particular, the material should be strongly transmissive for wavelengths around those generated by conventional microwave ovens, typically 12.2 cm (2.45 GHz). In the infrared waveband (0.75 μm-100 μm), on the other hand, the ideal material should be strongly reflective in order to retain the thermal energy emitted by the foodstuff as it is cooked. In conventional oven cooking this can be achieved by wrapping the foodstuff in conventional aluminium baking foil, a practice that is impossible in microwave cooking. By the same token, strong reflection in the IR waveband is required to prolong the transit time of chilled or frozen foodstuffs while out of refrigeration. In the ultra-violet and visible wavebands (9 nm-750 nm) the ideal material should also be highly reflective, to minimise food spoilage through discolouration and oxidation.

FIG. 3 includes plots of experimental results obtained from the uncoated polyester film. The microwave data was derived with a sample of the film interposed between suitable microwave transmitting and receiving horns, and the IR and UV/visible data was derived by use of a suitable light source and spectrometer. Since the polyester is shown to be strongly transmissive in the microwave waveband it is evident why polyester has previously been chosen as a conventional microwave packaging material. However its performance in the IR and UV/visible wavebands is far less suitable. Where an ideal material would display strong reflectance and weak transmission the polyester film is characterised by weak reflectance and strong transmission, thus imposing undesirable limitations on transit time and shelf life and failing to realise the advantages in cooking technique that the present invention may provide.

FIG. 4 includes plots of experimental results obtained from the FSS film according to the invention, derived in the same way as for the uncoated polyester film. The first important conclusion to be drawn from this data is that the use of the FSS film does not degrade the performance of the packaging in the microwave waveband as the FSS film remains substantially as transmissive as the base polyester film. However, it is in the IR and UV/visible wavebands that the performance of the FSS film substantially surpasses that of the polyester. Throughout these regions the FSS film is characterised by enhanced reflectance (greater than six-fold improvement) and significantly lowered transmission in comparison to the uncoated polyester. This represents a substantial improvement in the material's performance as a microwavable foodstuff packaging.

To demonstrate the thermally insulative properties of a material according to the invention the following experiment was performed. Three similar Maris Piper potatoes were taken, one was wrapped in an FSS film of the above composition, another was wrapped in the uncoated polyester film and the other was left unwrapped. The potatoes were heated separately in a microwave oven and the temperature at the centre of each was monitored by means of a thermocouple: When the centre temperature reached 100° C. in each case the respective potato was removed from the oven and stood at room temperature. Its centre temperature was monitored for the following 50 minutes and the resultant cooling curves for each potato are shown in FIG. 5. These results clearly show that heat loss was significantly reduced by the presence of the FSS film in comparison with both the unwrapped and polyester wrapped samples. For example the potato wrapped in the FSS film took an additional 11.5 minutes to cool down to 70° C. in comparison with the unwrapped potato (an improvement of 148% in standing time) and also outperformed the standard polyester film, taking an additional 10.1 minutes to cool down to 70° C. in comparison with the polyester wrapped potato (an improvement of 139% in standing time). Again, by the same token the FSS film according to the invention can significantly prolong the time for which a chilled or frozen foodstuff can remain out of refrigeration before thawing undesirably.

To demonstrate the effect on cooking uniformity of a material according to the invention the following experiment was performed. Rectangular samples (6×6×2.5 cm) of fresh chicken breasts were prepared. Two rectangular boxes were constructed, one from panels of an FSS film of the above composition and the other from panels of the uncoated polyester film. Chicken samples were placed in each box and heated separately for a specified time in a microwave oven. The respective samples were removed, sectioned and positioned immediately at the focus of a set of thermal cameras in order to measure the temperature profile across the partially cooked foodstuff. A simple sum-of-squares error approach was used to quantify the variation of the temperature profile across each sample from a uniform temperature. This analysis suggested a 50% improvement in uniformity of temperature across the sample was achieved by cooking in the FSS film packaging as compared with the standard polyester packaging.

FIG. 6 shows typical temperature profiles taken across the diagonal of chicken samples heated in the FSS and polyester film boxes. The data was taken after 60 seconds cooking at 70% power in a commercially available 800 W (max) microwave oven with rotating turntable, and has been normalised to a common maximum sample temperature so that the relative uniformity of the temperature profiles between the two samples may be compared directly. The temperature profile across the sample cooked in the FSS film packaging can be seen to be considerably more uniform than that cooked in standard polyester. The centre (minimum temperature region) of the FSS film packaged sample can be observed to reach 60% of the temperature at the outside edges (maximum temperature region), compared to only 40% for the polyester packaged sample. The significance is that when microwave cooking a foodstuff such as chicken it is normal, to ensure sufficient heating of the whole piece, that its edges become overcooked, leading to degradation in texture. The extent to which the edges overcook depends on the extent to which the edge temperature is higher than the centre temperature, in addition to the cooking duration. Hence the improvement in temperature uniformity observed with samples packaged in FSS film according to the invention can also enable a more consistent texture to be achieved in the cooked product.

FIG. 7 illustrates one particular form of a microwavable package according to the invention for a foodstuff 3. It comprises a semi-rigid tray 4 moulded from a conventional polymeric microwavable food packaging material with an FSS-coated polymer film 5 such as described with reference to FIGS. 1 and 2 laminated on its exterior, and an FSS-coated polymer film 6 such as described with reference to FIGS. 1 and 2 closing the top of the tray. Depending on the nature of the foodstuff to be cooked, in another embodiment the film 5 may be omitted and the tray 4 provided only with the FSS lidding film 6. If desired the tray 4 can be formed into a number of different compartments covered by respective FSS-coated films configured to provide different levels of microwave transparency and/or infrared reflectivity so as to optimise the heating conditions for different foodstuffs in the different compartments when exposed to the same microwave energy. The package could also include so-called microwave susceptors, which are discrete metal elements, not to be confused with an FSS patch array, which heat up when exposed to microwaves to produce browning effects in accordance with known techniques. FSS-coated films such as described with reference to FIGS. 1 and 2 may also be formed into flexible bags for packaging of micowavable foodstuffs, or pouches for the heating of home-prepared foods.

1. A material for use in covering objects for microwave heating comprising a substrate substantially transparent to microwave radiation bearing an array of low emissivity metal patch elements defining a frequency selective surface adapted to pass microwave radiation and reflect thermal infrared radiation, the characteristic dimension of said patch elements being no greater than about 1600 μm, the average spacing between said patch elements being no greater than about 200 μm and the combined emissivity of the substrate and patch elements being no greater than about 0.8 in the thermal infrared waveband.

2. A material according to claim 1 wherein said array is substantially transparent to radiation in the region of 2.45 GHz.

3. A material according to claim 1 wherein the characteristic dimension of said patch elements is no greater than about 500 μm and the average spacing between said patch elements is no greater than about 100 μm

4. A material according to claim 1 wherein the combined emissivity of the substrate and patch elements is no greater than about 0.4 in the thermal infrared waveband.

5. A material according to claim 4 wherein the combined emissivity of the substrate and patch elements is no greater than about 0.2 in the thermal infrared waveband.

6. A material according to claim 1 wherein said substrate comprises a film of polyester, polypropylene, polyethylene or nylon.

7. A material according to claim 1 wherein said patch elements are composed of aluminium, copper, gold, titanium or chromium.

8. A material according to claim 1 wherein said patch elements are in the shape of squares, rectangles, hexagons, circles or crosses.

9. A packaging material for microwavable foodstuff comprising a material according to claim 1.

10. A package for microwavable foodstuff comprising a material according to claim 1.

11. A packaged microwavable foodstuff wherein the package comprises a material according to claim 1.

12. A bandage or patch adapted to be worn on the body comprising a material according to claim 1.

13. A method of heating an object which comprises covering the object with a material according to claim 1 and exposing the material to microwave radiation.

14. A method of manufacturing a material according to claim 1 which comprises: taking a material comprising a substrate substantially transparent to microwave radiation upon which is vacuum deposited a continuous metal foil; applying an etch-resistant substance to the metal foil in patches corresponding to said array; and chemically etching away the metal exposed between the patches of etch-resistant substance.

15. A method of manufacturing a material according to claim 1 which comprises vacuum depositing a metal onto a substrate substantially transparent to microwave radiation through a mask with a pattern corresponding to said array.

16. A method of manufacturing a material according to claim 1 which comprises: taking a material comprising a metal foil with a heat-sensitive adhesive backing; bonding said foil to a substrate substantially transparent to microwave radiation with a heated stamp having a pattern corresponding to said array; and removing the portions of said foil left unbonded by said stamp.
